(19) United States
(12) Patent Application Publication
(10) Pub. No.: US 2004/0050650 A1
(43) Pub. Date: Mar. 18, 2004

(54) Money changer management system

(75) Inventor: Junichi Yamagishi, Taito-ku (JP)

Correspondence Address: JORDAN AND HAMBURG LLP, 122 EAST 42ND STREET, SUITE 4000, NEW YORK, NY, 10168, US

(73) Assignees: Unirec Co., Ltd., Taito-ku (JP); Junichi Yamagishi, Taito-ku (JP)

(21) Appl. No.: 10/242,942

(22) Filed: Sep. 12, 2002

(51) Int. Cl. G06F 7/00; G06F 9/00; G07F 9/08; G06F 19/00

(52) U.S. Cl. 194/217

(57) ABSTRACT

A money changer management system enables an easy inventory of a money changer (1) and prevents accidents. The system includes the money changer and a management unit (3). The money changer has a cabinet (5) having a lockable door (7), a lockable change unit (25) installed in the cabinet, to hold money and dispense money of equal value in exchange for money deposited into the money changer, the held, dispensed, and deposited money being at least one of paper money and hard money, and a circulator-counter (31, 33, 35) to count the money in the change unit while once circulating the money in the change unit. The management unit manages the money in the money changer according to information about the amount of the money in the money changer and information from the circulator-counter.

### BACKGROUND OF THE INVENTION

1. Field of the Invention

The present invention relates to a money changer management system applicable to, for example, amusement places and game arcades.

2. Description of the Related Art

An example of a money changer is disclosed in Japanese Patent Laid Open Publication No. 6-282721. This money changer has a cabinet, a lockable door provided for the cabinet, and a change unit installed in the cabinet, to change deposited money with money of equal value and dispense the money of equal value.

The cabinet and change unit are each lockable so that an authorized person having keys may open the cabinet and change unit and manage money in the change unit.

The money changer is installed in, for example, an amusement place. An inventory of the money changer is conducted, for example, every three to seven days, to inspect money in the money changer. The change unit in the money changer holds a predetermined amount of money in predetermined denominations. The amount of money in the money changer is unchanged through transactions although the denominations thereof may change. The inventory is conducted to examine whether or not the amount of money in the money changer is equal to the predetermined initial amount. The inventory is carried out by dispensing all money from the money changer, counting the money, and returning the money into the money changer. In this way, the inventory needs much time and labor.

To prevent accidents, inventories must be conducted at short intervals. In practice, however, an inventory is carried out every three to seven days due to the labor/time-taking nature of inventory.

The conventional money changer involves a risk of allowing a person having a key to borrow money from the money changer and return the money into the money changer before an inventory. Such a risk must be avoided to establish a good relationship between the owner of the money changer and employees who conduct inventories of the money changer.

A customer who uses the money changer may claim that the amount of dispensed money is short. To confirm whether or not the customer's claim is true, an inventory of the money changer must be carried out on the instant. This may take about 30 minutes.

### SUMMARY OF THE INVENTION

An object of the present invention is to provide a money changer management system capable of speedily carrying out an inventory of a money changer without opening the same.

A first aspect of the present invention provides a money changer management system including a money changer and a management unit. The money changer has a cabinet having a lockable door, a lockable change unit installed in the cabinet, to hold money and dispense money of equal value in exchange for money deposited into the money changer, the held, dispensed, and deposited money being at least one of paper money and hard money, and a circulator-counter to count the money in the change unit while once circulating the money in the change unit. The management unit manages the money in the money changer according to information about the amount of the money in the money changer and information from the circulator-counter.

A second aspect of the present invention provides the system of the first aspect with a first input unit to input information about a person who unlocks at least one of the door of the cabinet and the change unit, an unlock controller to collate the input information with registered information, and if the collation authenticates the person, unlock at least one of the door of the cabinet and the change unit, and a first recorder to record the authenticated person.

A third aspect of the present invention provides the system of any one of the first and second aspects with a second input unit to input information about a person who operates the management unit, an operation controller to collate the input information with registered information, and if the collation authenticates the person, allow the person to operate the management unit, and a second recorder to record the authenticated person.

A fourth aspect of the present invention employs biometric information as the information about the person mentioned in any one of the second and third aspects.

A fifth aspect of the present invention connects the money changer and management unit of any one of the first to fourth aspects to each other through a network.

According to the first aspect, the cabinet is lockable and incorporates the lockable change unit. The change unit dispenses money of equal value in exchange for money deposited into the change unit, the dispensed and deposited money being at least one of paper money and hard money. When conducting an inventory, the circulator-counter counts the money in the change unit while once circulating the money in the change unit and informs the management unit of the count. The management unit manages the money in the change unit according to information about the amount of the money in the change unit and the information from the circulator-counter.

An inventory can speedily be conducted without laborious operations of opening the cabinet, dispensing all money from the change unit, counting the money, and returning the money to the change unit. As a result, inventories can be conducted at shorter intervals. If a customer claims a shortage of changed money, an inventory will be conducted quickly to see if the customer's claim is true. This improves the quality of customer service. An inventory can be carried out without opening the cabinet, and therefore, a person who conducts the inventory is not required to touch the money in the cabinet. This prevents accidents related to inventories and maintains a good relationship between an employer who owns the system and employees who conduct inventories.

In addition to the effects of the first aspect, the second aspect employs the first input unit to input information about a person who unlocks at least one of the cabinet and change unit. The unlock controller collates the input information with registered information, and if the collation authenticates the person, unlocks at least one of the cabinet and change unit. Only an authenticated person is allowed to open one of the cabinet and change unit.

The first recorder records the authenticated person. Whenever a person opens the cabinet and change unit and touches the money in the cabinet, the name of the person and time are recorded. The recorded data is used to surely manage the money changer.

In addition to the effects of the first and second aspects, the third aspect employs the second input unit to input information about a person who operates the management unit. The operation controller collates the input information with registered information, and if the collation authenticates the person, allows the person to operate the management unit. Only the authenticated person is allowed to operate the management unit.

The second recorder records the authenticated person. The name of the person who operated the management unit and time are recorded. The recorded data is used to surely manage the management unit.

In addition to the effects of the second and third aspects, the fourth aspect employs biometric information of a person who opens the cabinet or operates the management unit, to improve security.

In addition to the effects of the first to fourth aspects, the fifth aspect connects the money changer and management unit to each other through a network, so that the money changer may easily be managed by the management unit that may be located at a remote place. From the remote place, the management unit can easily detect, for example, a shortage of money for change or the opening of the cabinet door.

### BRIEF DESCRIPTION OF THE DRAWINGS

FIG. 1 generally shows a money changer management system according to an embodiment of the present invention;

FIG. 2 is a block diagram showing a note changer in the system of FIG. 1;

FIG. 3 is a block diagram showing a coin changer in the system of FIG. 1;

FIG. 4 is a flowchart showing a fingerprint collation flow in a money changer of the system of FIG. 1; and

FIG. 5 is a flowchart showing a fingerprint collation flow in a management unit of the system of FIG. 1.

### DETAILED DESCRIPTION OF EMBODIMENTS

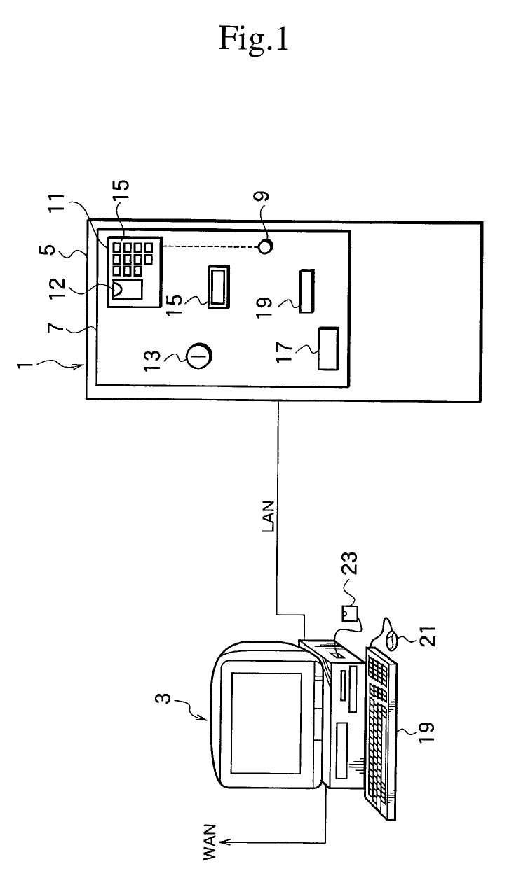

FIG. 1 generally shows a money changer management system according to an embodiment of the present invention. The system includes a money changer 1 and a management unit 3 that are connected to each other through a LAN.

The money changer 1 is installed in facilities such as an amusement place. Although FIG. 1 shows only one money changer, a plurality of money changers may be installed in one place. The money changer 1 is connected to the management unit 3 through a LAN. The management unit 3 may be connected to other money changers installed in different places through a WAN.

The money changer 1 has a cabinet 5 and a door 7 that is lockable with a lock 9. The lock 9 may be an electronic lock. The cabinet 5 has an authentication unit 11 having a fingerprint input unit 12 and a ten-key pad 15. The authentication unit 11 serves as a first input unit to make a person input identification information necessary for opening the door 7.

The fingerprint input unit 12 is used to input biometric information of a person who opens the door 7, such as the fingerprint of a specific finger of the person. The biometric information is not limited to a fingerprint. It may be information related to the eye, face, DNA, voiceprint, or venous pattern on the back of a hand of the person. The ten-key pad 15 is used to input, for example, an identification number of the person who opens the door 7. In this way, the embodiment uses the fingerprint information and identification number of a person who wants to open the door 7, to correctly identify the person. According to the embodiment, any one of the fingerprint information and identification number may be omitted to input. The ten-key pad 15 may be used for another purpose, for example, inputting commands.

The information entered through the authentication unit 11 is collated by the management unit 3 with registered information. If the collation authenticates the person, the authentication unit 11 sends a signal to open the lock 9. The management unit 3 and authentication unit 11 form an unlock controller.

When the lock 9 is unlocked, information on the authenticated person such as the name and employee number of the person, as well as time are recorded by the management unit 3. Accordingly, the management unit 3 serves as a first recorder.

The door 7 of the money changer 1 has a coin inlet 13 to deposit coins into the money changer 1, a note inlet 15 to deposit notes into the money changer 1, a coin outlet 17 to dispense coins, and a note outlet 19 to dispense notes. For example, a 500-yen coin is deposited into the coin inlet 13, and five 100-yen coins are dispensed from the coin outlet 17. For example, a 10,000-yen note is deposited into the note inlet 15, and ten 1,000-yen notes are dispensed from the note outlet 19. In this way, the money changer 1 changes various denominations into other denominations.

The management unit 3 is, for example, a desk-top personal computer and includes a keyboard 19, a mouse 21, a fingerprint authentication unit 23, and the like. The unit 23 is used to input a fingerprint as biometric information of a person who is going to operate the management unit 3. According to the embodiment, the unit 23 serves as a second input unit to input information on a person who operates the management unit 3. The biometric information may be not only information on a fingerprint but also information on an eye, a face, DNA, voiceprint, or venous pattern on the back of a hand.

The information entered through the fingerprint authentication unit 23 is collated with registered information. If the collation authenticates the person, the management unit 3 becomes operable. Accordingly, the management unit 3 serves as an operation controller.

When the management unit 3 is operated, information on the authenticated person such as the name and employee number of the person, as well as time are recorded in the management unit 3. The management unit 3, therefore, serves as a second recorder.

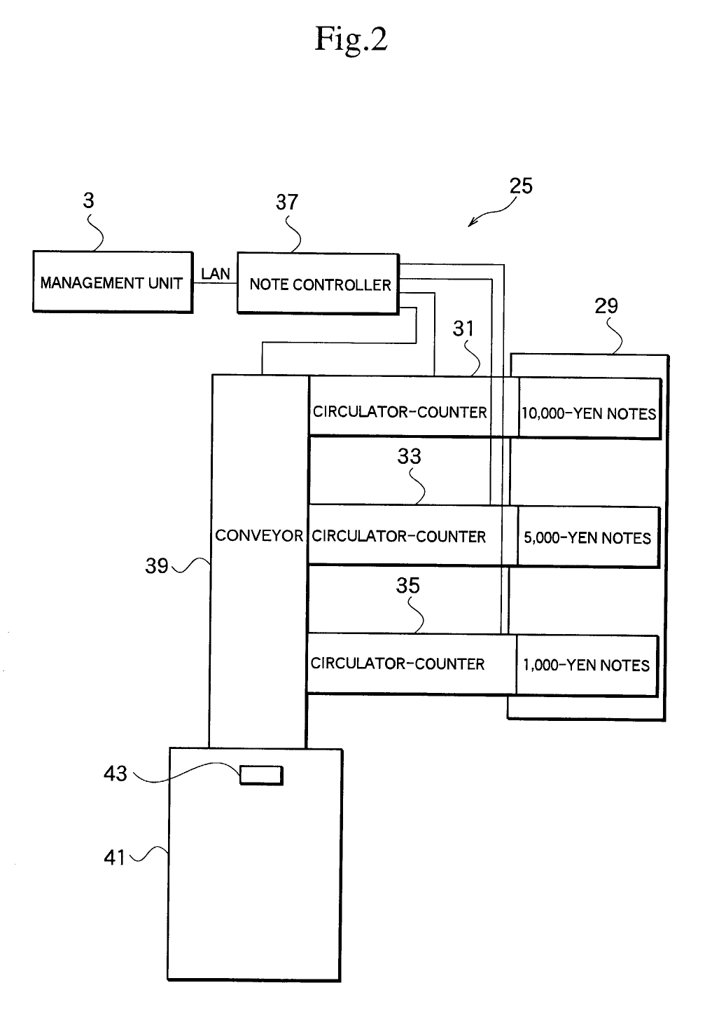

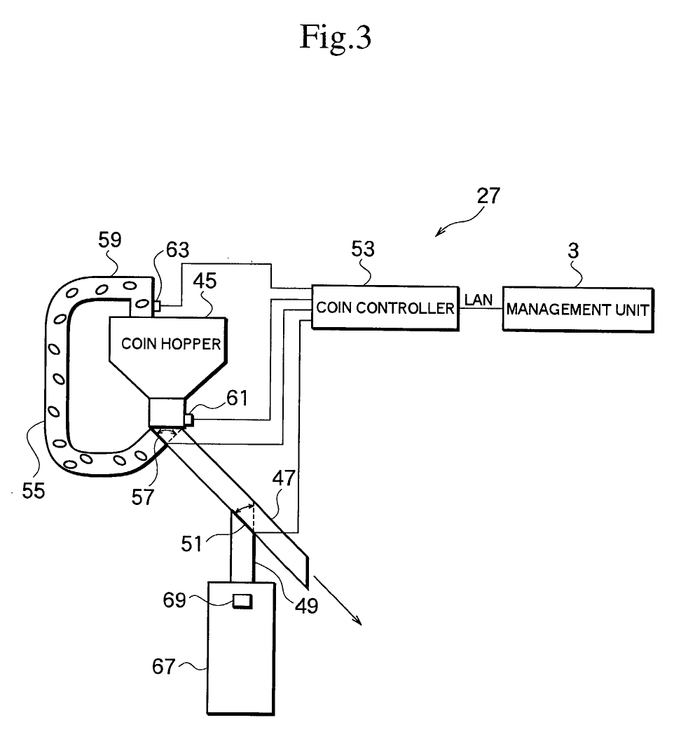

FIG. 2 is a block diagram showing a note changer 25 and FIG. 3 is a block diagram showing a coin changer 27 both installed in the cabinet 5.

In FIG. 2, the note changer 25 has a closed structure and is lockable. If the note changer 25 must be repaired or maintained due to, for example, a jam, it can be unlocked with a key. The note changer 25 has a note holder 29 to hold a predetermined amount of money in predetermined denominations such as 10,000-yen notes, 5,000-yen notes, and 1,000-yen notes. When a note is deposited into the note inlet 15 (FIG. 1), the note holder 29 dispenses notes of equal value from the note outlet 19. The deposited note is held in the note holder 29 according to the denomination thereof.

The note changer 25 has circulator-counters 31, 33, and 35 to count notes while once circulating them. The circulator-counters are provided for denominations, respectively. In this embodiment, they are provided for 10,000-yen notes, 5,000-yen notes, and 1,000-yen notes, respectively. The circulator-counters 31, 33, and 35 are controlled by a note controller 37, to successively pick up corresponding notes from the note holder 29, count them, and return them into the note holder 29.

The circulator-counters 31, 33, and 35 are connected to a conveyor 39, which is controlled by the note controller 37. The note controller 37 controls the conveyor 39 and circulator-counters 31, 33, and 35, to collect all notes from the note holder 29 into a collection box 41.

The collection box 41 is lockable and is detachable from the conveyor 39. After collecting all notes, the collection box 41 under a locked state can be taken out. The collection box 41 has an MPU, a memory, and the like, to hold money amounts counted by the circulator-counters 31, 33, and 35 and display them on a display 43.

In FIG. 3, the coin changer 27 has a closed structure and is lockable. If the coin changer 27 must be repaired or maintained due to, for example, a jam, it can be unlocked with a key. The coin changer 27 has a coin hopper 45 to hold coins. The hopper 45 initially holds a predetermined amount of money in predetermined denominations. For example, it holds 200 500-yen coins. Although FIG. 3 shows only one hopper for the sake of simplicity of explanation, an optional number of hoppers are employable for the system of FIG. 1. For example, three hoppers for different denominations may be arranged vertically. Under the hopper 45, there is a dispense path 47. A middle of the dispense path 47 is connected to a collection path 49. The dispense path 47 and collection path 49 are separated from each other with a switching door 51, which is driven by, for example, a motor. The motor is controlled by a coin controller 53.

Under the hopper 45, a circulation path 55 is branched from the dispense path 47 with a switching door 57 interposing between the paths 47 and 55. The switching door 57 is driven by, for example, a motor that is controlled by the coin controller 53.

The circulation path 55 has an upper outlet 59 facing the top of the hopper 45. The circulation path 55 is provided with, for example, a belt having protrusions to carry coins through the circulation path 55 up to the outlet 59. The belt is controlled by the coin controller 53.

The bottom of the hopper 45 is provided with a counting sensor 61, and the outlet 59 of the circulation path 55 is provided with a counting sensor 63. The sensors 61 and 63 provide count information to the coin controller 53.

The sensor 61 counts the number of coins flowing to, for example, the dispense path 47. The sensor 63 counts the number of coins circulated to the hopper 45 through the circulation path 55. Coins are circulated once from the hopper 45 through the circulation path 55 to the hopper 45, and during the circulation, the sensor 63 counts the number of the coins. The circulation path 55 and sensor 63 form a circulator-counter.

When notes or coins are deposited into the note inlet 15 or coin inlet 13, an equal value of money is dispensed from the hopper 45 to the coin outlet 17 through the dispense path 47. The deposited coins are held in the hopper 45 or other hoppers according to the denominations of the coins.

A lower end of the collection path 49 is provided with a detachable collection box 67. The collection box 67 is lockable. After collecting all coins through the collection path 49, the collection box 67 under a locked state is taken out. The collection box 67 may have an MPU, a memory, a display 69, and the like. The collection box 67 receives count information from the sensor 63, holds the information, and displays the information on the display 69.

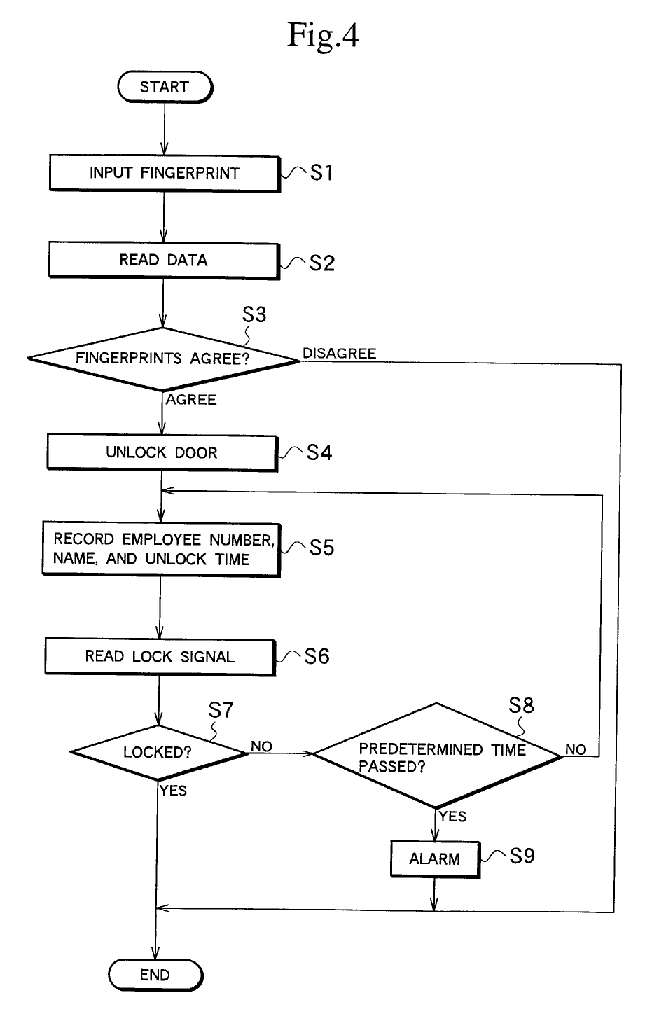

FIG. 4 is a flowchart showing a fingerprint collation flow carried out by the management unit 3. In step S1, a fingerprint is entered to open the door 7 (FIG. 1) of the cabinet 5. A person who is going to unlock the door 7 enters its fingerprint through the fingerprint input unit 12. Step S2 reads registered fingerprint data and personal data from a database into the management unit 3.

Step S3 carries out a collation. Namely, the management unit 3 collates the entered fingerprint with each of the registered fingerprints. If they agree with each other, step S4 is carried out, and if not, the flow ends to prevent any unauthorized person from opening the door 7.

Step S4 allows the door 7 to be unlocked. Namely, the authentication unit 11 sends an unlock signal to unlock the electronic lock 9. Then, the authenticated person can open the door 7.

Step S5 records the name and employee number of the person who unlocked the lock 9 and unlock time according to data related to the person and a signal from a timer.

Step S6 reads a door lock signal, which is an electric signal issued when the lock 9 is locked.

Step S7 determines whether or not the door 7 has been locked. If the locking of the door 7 is confirmed, the flow ends, and if not, step S8 is carried out. Step S8 determines whether or not a predetermined time has passed. The predetermined time includes a time for opening the door 7, a time for a person to carry out necessary work, a time for closing the door 7, and a marginal time. The predetermined time is optional and is, for example, one hour.

If step S8 determines that the predetermined time has not passed yet, step S5 is repeated. If step S8 determines that the predetermined time has passed, Step S9 issues an alarm such as a buzzing sound and ends the flow. Hearing the buzzing sound, the person who opened the door 7 may surely close and lock the door 7.

In this way, only a person authenticated through fingerprint collation is allowed to open the door 7 of the cabinet 5, and the employee number and name of the person and unlock time are recorded, to surely manage the money changer 1.

According to the embodiment, the door 7 of the cabinet 5 may be opened after fingerprint collation and the input of, for example, an employee number through the ten-key pad 15, to ensure the management of the money changer 1.

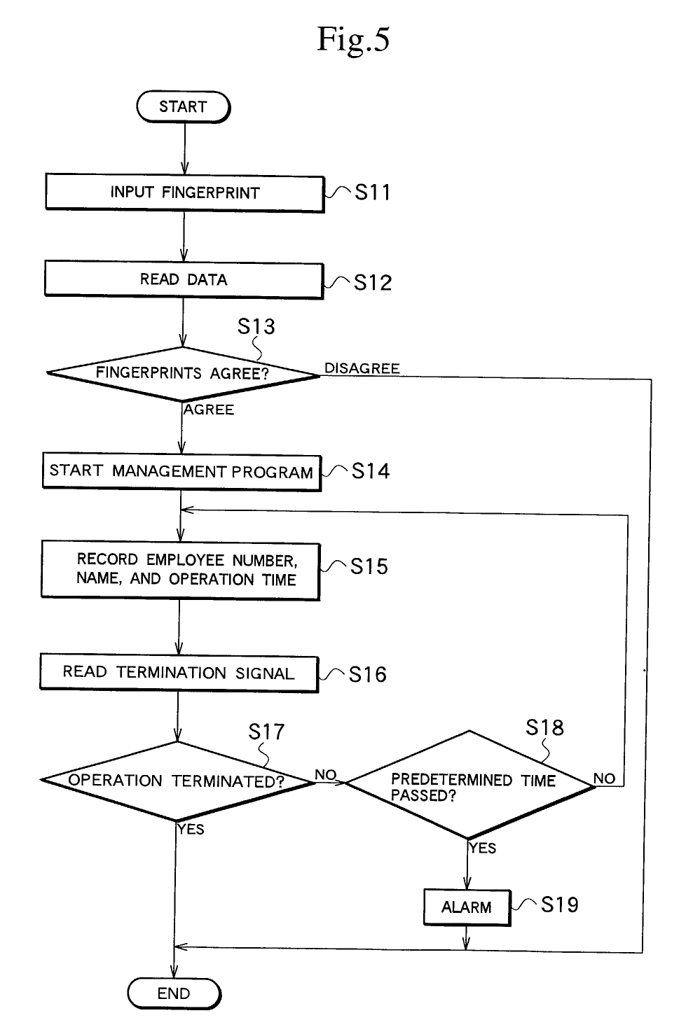

FIG. 5 is a flowchart showing a fingerprint collation flow carried out in the management unit 3, to operate the management unit 3. Steps S11, S12, S13, S15, S18, and S19 of FIG. 5 are the same as steps S1, S2, S3, S5, S8, and S9 of FIG. 4. Steps S14, S16 and S17 of FIG. 5 correspond to steps S4, S6, and S7 of FIG. 4. The steps of FIG. 5 relate to operating the management unit 3. After fingerprint collation, step S14 starts a management program to enable the operation of the management unit 3. Step S16 reads an end signal that is issued when the management program in the management unit 3 terminates. Step S17 determines whether or not the operation of the management unit 3 has terminated. If the management program of the management unit 3 has terminated, the flow ends. When the authenticated person operates the management unit 3, the employee number and name of the person and operation time are recorded to securely manage the money changer 1.

A person who uses the money changer 1 inserts a coin or a note into the coin inlet 13 or note inlet 15. The note changer 25 and coin changer 27 change the inserted note or coin into equal value of money and dispense the changed notes or coins from the coin outlet 17 or note outlet 19.

An inventory of the money changer 1 is carried out in response to a batch of commands from the management unit 3, or individual commands from the ten-key pad 15. In response to the commands, the note controller 37 and coin controller 53 carry out the inventory.

In the note changer 25, the circulator-counters 31, 33, and 35 are driven to circulate and count 10,000-yen notes, 5,000-yen notes, and 1,000-yen notes in the note holder 29 and provide count results to the management unit 3. During the inventory, the notes must not endlessly be circulated between the note holder 29 and the circulator-counters 31, 33, and 35. To prevent the endless circulation, counted notes are separated from notes not counted yet.

In the coin changer 27, the coin controller 53 controls the switching door 57 to pass coins from the hopper 45 to the circulation path 55. The coins in the circulation path 55 are returned into the hopper 45 through the outlet 59 and are counted by the sensor 63. Coins must not endlessly be circulated between the hopper 45 and the circulation path 55. To prevent the endless circulation, counted coins are separated from coins not counted yet. The count result from the sensor 63 is transferred to the management unit 3 through the coin controller 53.

An inventory of the money changer 1 is easily conducted by the management unit 3 without laborious operations of dispensing money of all denominations from the money changer 1, counting the money, and returning the money into the money changer 1. The embodiment can conduct inventories speedily at shorter intervals to correctly manage money in the money changer 1.

If a customer claims a shortage of changed money, the management unit 3 may issue a command or the money changer 1 may be used to enter a command, to speedily carry out an inventory and determine whether or not the customer's claim is true.

An inventory can be carried out without opening the door 7 of the money changer 1, and therefore, a person who conducts the inventory is not required to touch the money in the money changer 1. This prevents accidents related to the inventory.

If the money changer 1 must be opened, or if the management unit 3 must be operated, a fingerprint authentication is carried out on the person who opens the money changer 1 or operates the management unit 3, and at the same time, a log of the operation is recorded. It is possible, therefore, to confirm the person and time of the operation and surely manage the money changer 1.

The embodiment mentioned above unlocks the lock 9 after fingerprint collation. Another embodiment may electronically lock the note changer 25 and coin changer 27, to allow only a person authenticated through, for example, fingerprint collation to unlock the changers 25 and 27. Still another embodiment may unlock the lock 9 through fingerprint collation and the changers 25 and 27 with keys, or unlock the lock 9 with a key and the changers 25 and 27 through fingerprint collation.

To collect notes from the note changer 25, the note controller 37 drives the circulator-counters 31, 33, and 35 and conveyor 39. The notes in the note holder 29 are collected into the collection box 41 through the circulator-counters 31, 33, and 35 and conveyor 39. The collection box 41 under a locked state is taken out, so that no one may directly touch the notes when collecting the notes.

In the coin changer 27, the coin controller 53 controls the switching door 51 to collect coins from the hopper 45 into the collection box 67 through the collection path 49. The collection box 67 under a locked state is taken out without allowing anyone to directly touch the coins.

These configurations prevent accidents and maintain a good relationship between an employer who owns the money changer 1 and employees who handle the money changer 1.

What is claimed is:

1. A money changer management system comprising:
a money changer having:
a cabinet having a lockable door;
a lockable change unit installed in the cabinet, to hold money and dispense money of equal value in exchange for money deposited into the money changer, the held, dispensed, and deposited money being at least one of paper money and hard money; and
a circulator-counter to count the money in the change unit while once circulating the money in the change unit; and
a management unit to manage the money in the money changer according to information about the amount of the money in the money changer and information from the circulator-counter.

2. The system of claim 1, further comprising:
a first input unit installed on the cabinet, to input information about a person who unlocks at least one of the door of the cabinet and the change unit;
an unlock controller to collate the input information with registered information, and if the collation authenticates the person, unlock at least one of the door of the cabinet and the change unit; and
a first recorder to record the authenticated person.

3. The system of any one of claims 1, further comprising:
a second input unit provided for the management unit, to input information about a person who operates the management unit;
an operation controller to collate the input information with registered information, and if the collation authenticates the person, allow the person to operate the management unit; and
a second recorder to record the authenticated person.

4. The system of any one of claims 2, further comprising:
a second input unit provided for the management unit, to input information about a person who operates the management unit;
an operation controller to collate the input information with registered information, and if the collation authenticates the person, allow the person to operate the management unit; and
a second recorder to record the authenticated person.

5. The system of any one of claims 2, wherein:
the information about the person is biometric information about the person.

6. The system of any one of claims 3, wherein:
the information about the person is biometric information about the person.

7. The system of any one of claims 4, wherein:
the information about the person is biometric information about the person.

8. The system of any one of claims 1, wherein:
the money changer and the management unit are connected to each other through a network.

9. The system of any one of claims 2, wherein:
the money changer and the management unit are connected to each other through a network.

10. The system of any one of claims 3, wherein:
the money changer and the management unit are connected to each other through a network.

11. The system of any one of claims 4, wherein:
the money changer and the management unit are connected to each other through a network.

12. The system of any one of claims 5, wherein:
the money changer and the management unit are connected to each other through a network.

13. The system of any one of claims 6, wherein:
the money changer and the management unit are connected to each other through a network.

14. The system of any one of claims 7, wherein:
the money changer and the management unit are connected to each other through a network.
